(19) United States
(12) Patent Application Publication
(10) Pub. No.: US 2023/0353997 A1
(43) Pub. Date: Nov. 2, 2023

(54) METHOD AND SYSTEM FOR IMPROVEMENTS IN AND RELATING TO MICROSERVICES FOR MEC NETWORKS

(71) Applicant: Samsung Electronics Co., Ltd., Suwon-si, Gyeonggi-do (KR)

(72) Inventors: Walter FEATHERSTONE, Staines (GB); Nishant GUPTA, Bangalor (IN); Basavaraj Jayawant PATTAN, Staines (GB); Lalith KUMAR, Staines (GB); Nicholas HERRIOT, Staines (GB)

(21) Appl. No.: 17/793,296

(22) PCT Filed: Jan. 8, 2021
(86) PCT No.: PCT/KR2021/000236

§ 371 Date: Jul. 15, 2022

(30) Foreign Application Priority Data
Jan. 15, 2020 (IN) 202031001798
Jan. 29, 2020 (GB) 2001210.0
Dec. 23, 2020 (GB) 2020472.3

(51) Int. Cl. H04W 4/50; H04L 41/5054; H04L 41/50; H04W 64/00; H04W 28/08

(52) U.S. Cl. CPC H04W 4/50; H04L 41/5054; H04L 41/5096; H04W 64/00; H04W 28/0992

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail, security and safety services. Disclosed is a method of providing a service in a Multi-access Edge Computing, MEC, network, comprising the steps of: providing a pod in an edge cloud node, wherein the pod comprises a software container for providing an application that offers a service to one or more subscribers; associating with the pod a status related to an active or registered subscriber, wherein an active subscriber is currently interacting with the pod and a registered subscriber is not currently interacting with the pod, but has interacted previously; wherein, provided that the pod has at least one registered subscriber, the pod is maintained in the edge cloud node.

### CROSS-REFERENCE TO RELATED APPLICATION(S)

This application is a U.S. National Stage application under 35 U.S.C. § 371 of an International application number PCT/KR2021/000236, filed on Jan. 8, 2021, which is based on and claims priority of an Indian patent application number 202031001798, filed on Jan. 15, 2020, in the Indian Intellectual Property Office, of a United Kingdom patent application number 2001210.0, filed on Jan. 29, 2020, in the United Kingdom Intellectual Property Office, and of a United Kingdom patent application number 2020472.3, filed on Dec. 23, 2020, in the United Kingdom Intellectual Property Office, the disclosure of each of which is incorporated by reference herein in its entirety.

### TECHNICAL FIELD

The present invention relates to a Multi-access Edge Computing (MEC) network, which is a network where certain services or functions are provided at the network's edge i.e. in the vicinity of a user, or local to the client's infrastructure, rather than in a centralized (or even dispersed) cloud.

### BACKGROUND ART

To meet the demand for wireless data traffic having increased since deployment of 4G communication systems, efforts have been made to develop an improved 5G or pre-5G communication system. Therefore, the 5G or pre-5G communication system is also called a ‘Beyond 4G Network’ or a ‘Post LTE System’. The 5G communication system is considered to be implemented in higher frequency (mmWave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

a Multi-access Edge Computing (MEC) network is a network where certain services or functions are provided at the network's edge i.e. in the vicinity of a user, or local to the client's infrastructure, rather than in a centralized (or even dispersed) cloud.

This form of network architecture allows cloud computing capabilities and IT service environments to operate on the edge of a mobile network. This architecture has a number of significant advantages, such as allowing services to be provided to the end user with substantially reduced latency. However, two aspects of this technology are problematic to the Network Operator. The first is Capital Expenditure (CAPEX), which can be substantial for even a basic system with no clear use case for return on investment. The second is latency in migrating a service from one edge network to another for a subscriber who is mobile. Any resulting service interruption diminishes the advantages of deploying services at the edge of the network.

One seemingly obvious solution to this is to deploy all services to all edge networks for all subscribers, even if they are not using that service, or never registered on an edge network that has the service installed. This means that the mobile operator has to dimension their MEC for all services and all subscribers for every MEC in their network. This is prohibitively expensive in practice and so does not represent a realistic solution.

Furthermore, the idea of migrating services and contexts (the user/subscriber specific instantaneous state of the service, or application, i.e. all the information required in order to re-establish the service or application in a new location in exactly the same situation as the previous location) across roamed networks has the same issues. There would likely be resistance from a first mobile operator (A) allowing a second mobile operator (B) to deploy all services on their MEC for the chance that subscribers from A may roam and use that service on network B.

MEC systems are known in the art and are typically provided to offer consumers an improved performance by physically locating certain resources at the edge of the network i.e. remote from the central core or internet, but close to the consumer.

FIG. 12 shows a typical MEC system 100 and how it relates to other entities in the system. A plurality of user types 10 are able to connect to the MEC system 100. Such users 10 can access the MEC system 100 via fixed wire schemes, WiFi or cellular technologies, such as LTE or 5G, for instance.

The MEC system 100 comprises various further entities, including locally hosted applications (apps) and if the user 10 requests access to such an app, then the MEC system 100 is able to provide access to the user without recourse to any remote server or resource.

Such remote resources may, if needed, be accessed via core network 110 which is able to utilise resources in a centralized cloud 120 and/or the internet 130.

MEC systems 100 are necessarily localised and the availability of a particular resource to a user depends where that user is located and to which MEC system it has access.

An issue with MEC systems is service continuity, particularly as a user moves around and accesses services offered by different MEC application hosting environments within a single MEC system or across different MEC systems or when switching between a service offered in the cloud and a MEC system. Different solutions have been proposed whereby different entities (e.g. known entities such as application client, Edge Enabler Client (EEC), Edge Enabler Server (EES) or Edge Application Server (EAS)) may determine the need for application user context relocation.

However, the currently proposed solutions are reactive, since application user context relocation is only initiated once an alternative application server instance has been deemed to be preferable. As a consequence, there will be a service interruption during the application user context relocation.

### DISCLOSURE OF INVENTION

### Technical Problem

It is an aim of embodiments of the present invention to provide seamless service continuity in the aforementioned context.

Embodiments of the present invention aim to address shortcomings in the prior art, whether mentioned herein or not.

### Solution to Problem

According to the present invention there is provided an apparatus and method as set forth in the appended claims. Other features of the invention will be apparent from the dependent claims, and the description which follows.

According to a first aspect of the present invention, there is provided a method of providing a service in a Multi-access Edge Computing, MEC, network, comprising the steps of: providing a pod in an edge cloud node, wherein the pod comprises a software container for providing an application that offers a service to one or more subscribers; associating with the pod a status related to an active or registered subscriber, wherein an active subscriber is currently interacting with the pod and a registered subscriber is not currently interacting with the pod, but has interacted previously; wherein, provided that the pod has at least one registered subscriber, the pod is maintained in the edge cloud node.

In an embodiment, a particular subscriber is held in a registered state until one or more of the following conditions apply: a configurable time period has elapsed; the particular subscriber is no longer registered with the service; or the particular subscriber becomes an active subscriber.

In an embodiment, if the pod has no active or registered subscribers, the pod is deleted.

In an embodiment, the pod is deleted only after the configurable time period has elapsed.

In an embodiment, the configurable time period is determined on the basis of behaviour patterns of one or more subscribers.

In an embodiment, a user context associated with an active subscriber at the pod is made available to one or more other pods.

In an embodiment, the user context is made available by means of an ambassador pattern operable to replicate data between the pod and the one or more other pods. The one or more other pods may exist in the same edge cloud node as the original pod or may exist in one or more other edge cloud nodes.

In an embodiment, determining the one or more other pods is performed on the basis of a prediction of the subscriber's behaviour.

In an embodiment, the prediction is based upon one or more of: the subscriber's previous movements; and the subscriber's current position and/or speed and/or direction of travel.

According to a second aspect of the present invention, there is provided a system comprising an edge cloud node and a plurality of pods operable to perform the method of the first aspect.

In an embodiment, the system comprises at least one pod associated with at least one registered or active subscriber.

In an embodiment, there is further provided a cluster network manager operable to manage services available on particular pods.

Embodiments of the invention adopt a novel use of the ambassador pattern (one of the standard design patterns for cloud compute systems) to replicate data between edge clusters to achieve consistent persisted context, which means that a subscriber's user context is continually updated to all Persistent Volume Claims PVCs. The result is seamless service migration since, when a UE is switched from one edge cloud node to another, no user context update is required, because it is already replicated at the target node. This means that the UE's access to the service can continue uninterrupted.

In order to ensure that services are available at the required edge network locations, embodiments of the invention introduce the concept of a ‘static’ Pod (where the Pod is the service provider in Kubernetes terminology). Such a Pod has the ability to remain in an edge network even after all registered users are no longer active and is therefore protected from termination.

In order to manage the availability of the distributed Pods embodiments of the invention introduce a centralized Cluster Network Manager (CNM). In the ETSI MEC architecture, such an entity may be collocated with the MEC Orchestrator (termed MEC Application Orchestrator in a Network Function Virtualisation deployment).

Embodiments of the invention provide a way for a network to deploy services in the form of software containers to MEC networks that a user normally registers on (e.g. the common Monday to Friday cells a user registers on will only have those services that are unique to that user or group of users). In this way the number of active services deployed to a MEC will only ever be for the typical users that camp on those cell sites within that MEC.

Embodiments of the invention will reduce, possibly significantly, the required CAPEX for typical MEC deployments. Furthermore, they will remove latency in service migration in a solution where services are migrated, or a solution where services only follow the user and require constant deletion and creation across MEC networks.

According to a third aspect of the present invention, there is provided a method of managing User Equipment, UE, access to a particular application in a telecommunication network, comprising the steps of: the network serving the UE from a first application server instance; the network detecting the UE's presence within an overlapping region of coverage between a coverage area of the first application server and a coverage area of a second application server; the network, as a result of detecting, establishing a duplicate of the UE's application user context at the second application server instance

In an embodiment, one of the first and second application servers is associated with a MEC network.

In an embodiment, the first and second application servers are each associated with a different MEC network.

In an embodiment, a threshold for detecting entry into the overlapping region differs from a threshold for detecting exit from the overlapping region.

In an embodiment, the step of detecting the UE's presence within an overlapping region of coverage is based on the UE's location, determined by one or more of: location information provided by the UE; geolocation of the UE; RF signal related information provided by the UE or telecommunication network relating to the serving and neighbouring cells; a Timing Advance associate with the UE; and serving cell information.

In an embodiment, a traffic rule is invoked whereby data traffic is steered to both the first and the second application server such that the UE's application user context can be maintained at the first application server instance and the second application server instance.

In an embodiment, responses from the first and second application server instances are compared to check if synchronisation is being maintained.

In an embodiment, if synchronisation in not being maintained, initiating a synchronisation recovery procedure.

In an embodiment, the overlapping region of coverage is either static or dynamic.

In an embodiment, the overlapping region of coverage is dynamic, it is defined on the basis of one or more of resource availability in the network; and a UE-specific characteristic.

In an embodiment, the UE-specific characteristic is one of pedestrian status; vehicular status; and velocity.

In an embodiment, the duplicate of the UE's application user context at the second application server instance is maintained until the UE returns to the coverage area of the first application server or becomes served by the second application server instance.

In an embodiment, if the UE becomes served by the second application server instance and is still in the overlapping region, then a duplicate of the UE's application user context is maintained at the first application server instance and if the UE is not in the overlapping region, then the duplicate of the UE's application user context at the first application server instance is deleted.

According to a fourth aspect of the present invention, there is provided system operable to perform the method of the third aspect.

Embodiments of the present invention offer distinct advantages over the prior art.

Embodiments of the present invention provide an overlapping area definition between the service areas of two or more application servers where one or more of the application servers is hosted by a MEC system.

Embodiments of the present invention provide that the overlapping area definition includes UE specific characteristics, e.g. velocity, vehicular status (potentially associating with a specific road), pedestrian user status. Further, the same overlapping area definition may be applied to UEs with similar characteristics.

Embodiments of the present invention provide that separate criteria (e.g. different boundary locations) are defined for entry and exit into an overlapping area to introduce hysteresis, thereby assisting in preventing a UE ping-ponging (or rapidly entering and exiting) between being considered in and out of an overlapping area.

Embodiments of the present invention provide that the overlapping area definition may be dynamically adjusted according to Edge Data Network (EDN) resource availability (e.g. the overlapping area may be shrunk if resource is currently scarce).

Embodiments of the present invention provide that the EDN Configuration Server (EDNCS), which has visibility across the network, maintains and shares the overlapping area definition with the distributed EES in the network, or that each EES maintains its own overlapping area definitions. The default overlapping area definition may be fine-tuned according to the application characteristics and UE characteristics. The latter being assessed by the EES. In addition, the overlapping area definition may be dynamically adjusted according to changes in EDN resource availability.

Embodiments of the present invention provide that the EES in the network determines whether a UE has entered, or exited an overlapping region using a geolocation algorithm. Also, actions resulting from entry and exist into an overlapping region are initiated within the network, specifically the EES. The geolocation algorithm may take user plane management information (including serving cell information, timing advance, UE serving/neighbour cell signal quality/strength measurement information) and input from the UE itself.

Embodiments of the present invention provide that there may be a centralized EES that is associated with application instances currently hosted in the cloud, which would benefit from a move to the edge, to detect UE entry into an overlapping region with the edge.

Embodiments of the invention provide that the EES associated with each EDN is responsible for detecting a UE's entry and exit into/from an overlapping region but, in an alternative embodiment, that detection could be performed in a centralized manner.

Embodiments of the present invention provide that the peer EES entities are responsible for invoking the traffic rules in the data plane to ensure the application layer traffic is routed towards the duplicate application server instances whilst the UE is within an overlapping area. The EES with which the serving application instance server is associated, also has application server instance synchronisation management capabilities, for instance, to invoke comparison (within the data plane, or through a separate comparison entity) of responses from each application server instance to check synchronisation is being maintained. Should a loss of synchronisation be detected, the EES may initiate synchronisation recovery procedures.

By providing the intelligence in the network, rather than in the UE, more efficient and responsive control can be achieved, ensuring that the network entity best suited to making such decisions (i.e. the network) does so.

Although a few preferred embodiments of the present invention have been shown and described, it will be appreciated by those skilled in the art that various changes and modifications might be made without departing from the scope of the invention, as defined in the appended claims.

### BRIEF DESCRIPTION OF DRAWINGS

For a better understanding of the invention, and to show how embodiments of the same may be carried into effect, reference will now be made, by way of example only, to the accompanying diagrammatic drawings in which:

FIG. 1 shows a representation of typical users in terms of radio cell nodes visited;

FIG. 2 shows a typical prior art cloud-based system architecture;

FIG. 3 shows an architecture according to an embodiment of the present invention comprising static pods;

FIG. 4 shows a cluster deployment according to an embodiment of the present invention;

FIG. 5 shows a cluster network manager according to an embodiment of the present invention;

FIG. 6 shows an ambassador pattern in a system according to an embodiment of the present invention;

FIG. 7 shows a typical MEC system reference architecture according to the prior art;

FIG. 8 shows a message flow illustrating monitored event notification according to an embodiment of the present invention;

FIG. 9 shows a message flow illustrating the instantiation of an application according to an embodiment of the present invention;

FIG. 10 shows a message flow illustrating the MEP making a request to the MEO to instantiate an application according to an embodiment of the present invention;

FIG. 11 shows a message flow illustrating notification by the MEO of changes in application instance location(s)/address(es) according to an embodiment of the present invention;

FIG. 12 shows a known MEC system and its related entities;

FIG. 13 shows an application architecture for enabling edge applications;

FIG. 14 illustrates the concept of overlapping areas between EDNs or equally application service areas;

FIGS. 15a and 15b illustrates application mobility flow according to an embodiment of the present invention;

FIG. 16 illustrates EAS duplication according to an embodiment of the present invention; and

FIG. 17 illustrates EAS duplication, post-handover, according to an embodiment of the present invention.

### MODE FOR THE INVENTION

Embodiments of the invention provide a way to optimize cloud compute infrastructure on a MEC network, such that it only has deployed service containers and user context for the users that typically migrate to and use (or have used) that particular edge network.

The following description uses terms commonly used in cloud compute environments—specifically from the Kubernetes systems—but is equally applicable to any cloud based system. Cloud based networks typically describe how a network can automatically manage, connectivity, containerized workloads, lifecycle management and services, that facilitates both declarative configuration and automation. This means that an application developer does not have to think about, or build into their system: Network resilience; Deployment; Load balancing; Dimensioning of a system (i.e. the system horizontally scales); and Administration & Logging (health checks and aliveness reporting).

In this way the system is responsible for the application state, responsiveness and scalability. It makes sure that ‘workers’ are spawned, instantiated and provide service for the end user. The whole life cycle management is performed by the cloud compute infrastructure. In the example case presented herein, ‘Kubernetes’ is used as an example, but the skilled person will recognise that other systems or solutions are equally applicable. It uses a container system to spawn and manage deployed services to its compute cluster of nodes. It provides, as mentioned, scalability (i.e. bringing up workers and load balancing when needed), back-end services to scale databases and persistence, IP mapping of services to allow dynamic routing, administration and logging.

Embodiments of the invention reduce the typical required footprint of a MEC deployment and improve the way services are added and removed dynamically to a deployed MEC network. The typical solution for MEC networks is to deploy ‘containers’ (lightweight deployable software packages which contain an Operating System (OS) and software required to run a service) that can support all subscribers on that network, even if no subscriber actually uses that service, or if a user no longer uses the service on that edge network.

The cost of infrastructure on the edge is expensive. It should be capable of spawning services for users that exist on that mobile network. Spawning a service on an edge network is not instantaneous or real time compared to typical telecom services that are built into the Core Network (CN). This means that to reduce a time to activate a service, a network could, in theory, deploy all services for all users on all edge networks. This would mean that all edge points have to be able to support all services for all users at all times. This would lead to a large increase in the CAPEX of a deployed edge network.

Further, migrating services when needed, as users migrate from one edge network to another, increases delay/latency, network traffic and degrades the user experience. This can be illustrated by considering a game edge service where moving from one cell location to another causes the game to hang due to latency.

Embodiments of the invention provide a way to address and alleviate these and other issues, i.e. to remove delay in migrating user services from one edge point to another and reduce CAPEX required for a MEC network that can support all users for all services on a mobile network.

The smallest development container using Ubuntu as the container host OS is approx. 100 MB before a service is deployed.

For a production system, a service can be deployed on ‘Alpine Linux’ containers which are around 5-10 MB before any service is deployed.

As will be appreciated, this would substantially impact a MEC network if containers are continually being deployed and removed due to subscriber movements. An alternative consideration would be the impact of a MEC network having services never being used but consuming compute resources.

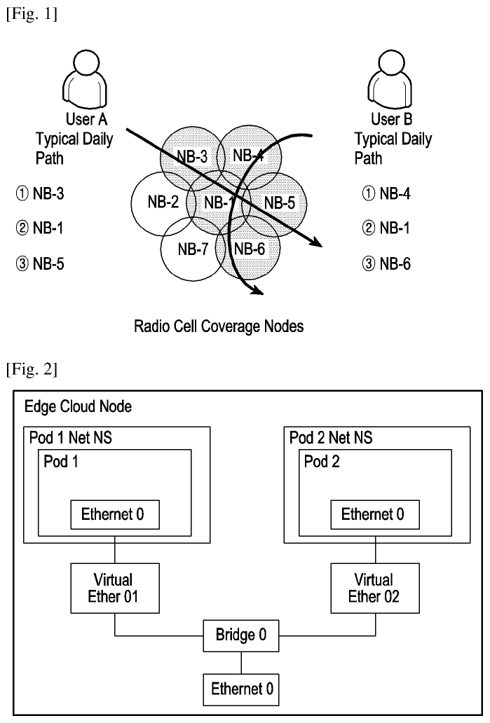

There are situations where a user will move between the same cell sites on a day-to-day basis, with changes to such use patterns happening infrequently. For example, a person who is in the same job will likely move between the same cell sites from Monday to Friday. The cell sites are termed NodeB, eNodeB, or gNodeB in a 3G, 4G and 5G networks respectively, but are all simply referred to as NB in the context of this application. FIG. 1 shows the typical path taken by two users—User A and User B.

When utilising services offered by the mobile network (e.g. internet connectivity), User A will attach to NB-3, NB-1 and NB-5 over the course of each day based on their typical behaviour. Likewise, User B will typically attach with only NB-4, NB-1 and NB-6 over the course of a day. When such users utilise centralized cloud services via the core network, the fact that they attach to the mobile network through different (relatively closely spaced) NBs has little impact on ideal physical location of the serving cloud servers. However, in a MEC deployment where the “cloud like” services are offered through localised edge data networks (that may only be associated with a limited number of NBs) the physical location of the server, and what services are offered by each server, can become critical.

For instance, if there is an edge data network associated with each NB, then when a user is attached to a particular NB, it is likely the associated edge data network will be the most appropriate to serve that user. In support of that, embodiments of this invention address the problem of ensuring the required services are available at each edge point as they are required, without the need to deploy all services at all edge points, thereby addressing CAPEX and latency issues.

In the context of this application, the deployment and management of services is herein termed Enhanced Mobility for MicroServices. The term MicroServices is used since applications providing services deployed in a cloud based system typically adopt a microservice based design pattern. With this approach applications are offered as a collection of loosely coupled microservices, rather than as a single monolithic application. Each microservice is likely to have a narrower scope focused on a particular task. Such microservices then communicate between one another in order to provide an overall service, such as the Netflix or BBC I-Player application service. A container may then be used to package, deploy and run the application.

Initially, with this Enhanced Mobility For MicroServices approach, according to embodiments of the invention, services are deployed as a user moves from one edge network to another. This may be performed in a pre-emptive manner, if it is determined that a user is likely to move into the service area of new edge network. This involves building up a picture of the utilisation of services based on a user's typical behaviour. This is in order to make future service deployment decisions and suitable retention time periods for those deployments. This is defined herein as the ‘configuration time period’.

For instance, based on a user's daily routine, if they typically utilise the Netflix service between the hours of 7 pm and 11 pm whilst attached to NB-3 the system will ensure (as far as possible, given other resource constraints) that the Netflix service is available in a time period that overlaps with that time in the edge network that has an association with that NB.

Given the picture built up for each service over time (which may include user granularity, i.e. specific user utilisation of a service), Enhanced Mobility For MicroServices according to an embodiment will retain a particular service at an edge point even if users are not actively using it. If a user has been active on that edge point within the ‘configuration time period’ the service is kept active within the edge data network that has the association to the particular NB. If the ‘configuration time period’ has expired, the service is removed from the cluster, freeing up resources for other services.

With specific user knowledge (i.e. the predicted times at which a particular user may use a service in a particular location), the Enhanced Mobility For MicroServices approach according to an embodiment of the invention ensures availability of the context associated with the use of the particular service at edge point(s) that it is anticipated a user may connect to (via attachment to the NB that is associated with the edge data network). Such user context may be associated with an on-going service (e.g. mid-game play), or that associated with resuming service (e.g. resuming a game at a particular point, level, score, media content, etc.). To achieve this, embodiments employ a novel use of the cloud computing “ambassador” design pattern for container-based distributed systems to replicate data between edge clusters.

Embodiments of the invention employ two major components: the first relates to the management of the physical deployment of pods with service containers (a software bundle containing the OS and all software libraries required to run the service); and the second relates to how a user context is managed for containers that are already active.

The Enhanced Mobility for MicroServices system according to an embodiment introduces a ‘pod’ classification, where a ‘pod’ is defined in Kubernetes terminology as a collection of related tightly-coupled containers providing a single function or service. In the context of embodiments of the invention, a ‘pod’ is classified as ‘static’ when it has the ability to remain in an edge network after all registered users are no longer using the pod and is therefore protected from termination. Pods are classified as ‘legacy’ if they do not support the Enhanced Mobility for MicroServices capability. With prior art container orchestration approaches, pods remain by default consuming resources until explicitly terminated without considering the registration state of users. If ‘pods’ were to migrate with users, which is also possible, it also has a drawback, that there is a lag in re-establishing the pod should a user wish to use the pod provided service once again. This lag would be even more problematic for a user using a service in one cloud node that moves to another and wishes to use the service there. Such a situation arises in particular with the introduction of edge computing, where the cloud nodes are physically separated (edge cloud nodes) and it is desirable for users to connect to the edge cloud node geographically closest to them.

A typical cloud based system, based on Kubernetes techniques, has an architecture comparable to that shown in FIG. 2. In such a system, a ‘pod’ containing a software container will be maintained throughout its lifetime. The cloud compute platform (Edge Cloud Node) provides dynamic routing between pods, via the Virtual Ethernet adapters (Virtual Ether 01 & 02) and the bridge (Bridge 0). It is also able scale a service, when needed, via replication.

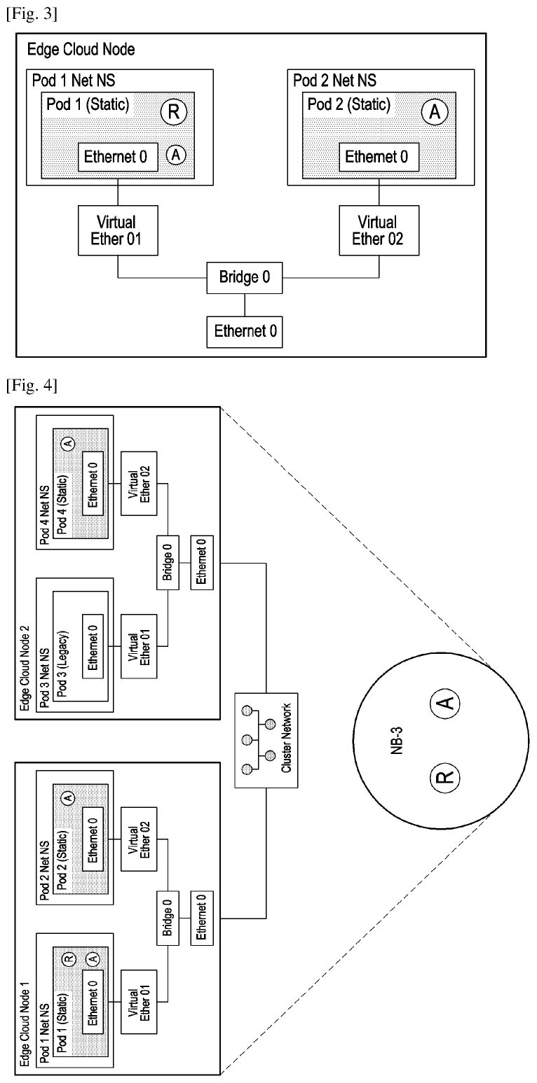

In the enhanced mobility system, according to an embodiment of the invention, pods that are labelled as ‘Static’ are given the capability to remain on the edge cloud node. In FIG. 3, the static Pod 1 has metadata marked as ‘static’ and has registered subscribers and active subscribers. Throughout the figures in this application registered subscribers are indicated by an R in a circle (®) and active subscribers are indicated by an A in a circle (\textcircled{A}).

Here, active subscriber denotes a subscriber who is registered on this MEC node for the particular service in question and is currently interacting with the service with associated information exchanges. Registered subscriber denotes a subscriber who is registered on this MEC node for the particular service in question (if that is applicable for that service) and at a point in the past was in an active state. Users are held in a ‘registered’ state until one of:
A) The ‘Configurable time period’ has elapsed
B) They are physically de-registered for that service (e.g. no longer a Netflix customer for the Netflix Service)
C) The subscriber hands over to a NB associated with the edge cloud node and transitions to ‘active’ state by interacting with the service.

The system may select users for pre-emptive removal in order to free up edge cloud node resources, e.g. to allow other pods to be created.

When there are no registered or active subscribers on a static pod, it is removed from the node.

FIG. 3 shows 2 pods. In pod 1 there is a registered subscriber and an active subscriber. In pod 2 there is an active subscriber. Should the active subscriber in Pod 2 move to a different cell site with a different edge network, the subscriber status would change to ‘Registered’. Maintaining records of when a subscriber enters and registers on a cell allows the pod to be managed efficiently. Once a pod only has ‘registered’ subscribers it will be removed from the cluster once the ‘Configurable time period’ has elapsed.

Each pod is given a ‘time-to-live’ based on a configuration period timeout defined previously. This period can be configured on a pod by pod basis or can be a default value for the network. In the case of Kubernetes, this can be obtained by querying the administration system (that will maintain the appropriate configuration period timeout for each pod) in the same way as the health, and aliveness checks commonly used in such a system. Hence, for a typical service, there are REST endpoints for health, aliveness, and time-to-live. The time-to-live period will always be taken from the point of the last user to switch their status to ‘registered’.

The architecture of the enhanced mobility functionality deployed on an edge network corresponds exactly to the typical cloud-based system architecture of FIG. 2, with the inclusion of the static pod concept shown in FIG. 3.

FIG. 4 shows an expanded deployment according to an embodiment of the invention in which a cluster of edge cloud nodes (Edge Cloud Nodes 1 and 2) is deployed for cell site NB-3, for the scenario first presented in FIG. 1. Associated with the cell site NB-3 is a deployed edge network consisting of 2 edge cloud nodes that support 4 pods in total. Of the 4 pods, 3 pods are static (pods 1-3) and one pod (pod 4) is a legacy ‘pod’, for which enhanced mobility functionality according to an embodiment of the invention does not apply. The cell site is shown with active and registered subscribers, based on the subscribers' status within the edge network. Within the edge network, Pods 1, 2 and 4 will be removed if the active user moves from the cell site and the local configuration time period has expired on each of those assets.

According to prior art procedures, dynamic routing is performed within the ‘Cluster Network’ logical block. Hence, any service mapped to a URL is routed to the correct Pod. If Pod 1 takes heavy traffic and the aliveness endpoint fails, Kubernetes will instantiate another pod replicating the pod and will automatically load balance between those pods.

A new element according to an embodiment of this invention is a Cluster Network Manager (CNM). To understand this, consider the case where there are two cell sites (NB-3 and NB-1, which were first shown in FIG. 1).

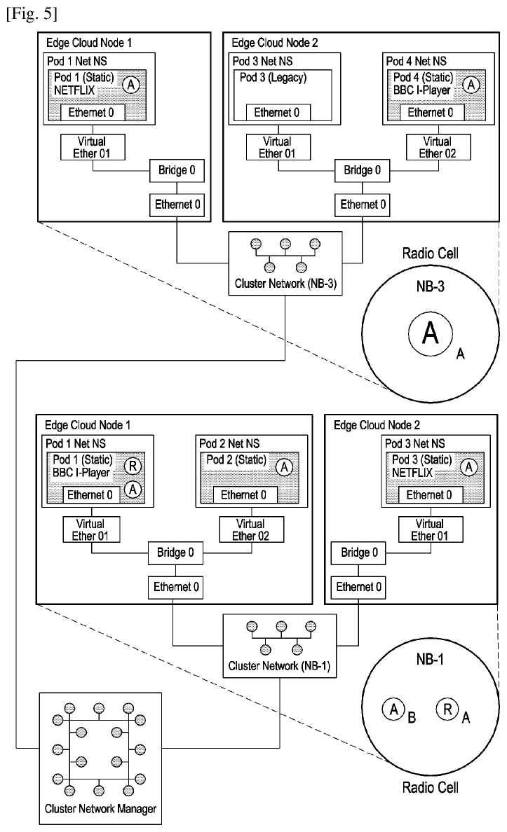

In this scenario each cell site has a deployed edge network that contains a number of Kubernetes nodes and pods. This is shown in more detail in FIG. 5. Nodes NB-3 and NB-1 take care of the deletion of pods simply using the metric for active subscribers and time-to-live of the pod. However a decision is required on what services to deploy for what subscriber within each MEC cluster network.

Notification of a subscriber happens via the Core Network (CN) or an app on the handset of the user. At this point a request is made to the CNM, shown in FIG. 5. The CNM is responsible for all MEC cluster networks across the mobile network.

For example, when ‘User A’ wishes to use, for instance, the BBC I-Player service and attaches to the mobile network via NB-1, the CNM is responsible for ensuring that a BBC I-Player pod is available (in this instance, on cluster 1 with pod number 1). The CNM will inform the edge network at NB-1 to create services (pods) for User A if they do not exist. The CNM knows what services are registered for which sub scriber.

In the prior art ETSI MEC architecture the MEC Orchestrator (MEO), or MEC Application Orchestrator (MEAO) in a Network Function Virtualisation (NFV) based deployment, is responsible for service instantiation. However, requests for service instantiation are only made via the Operations Support System (OSS) and therefore the MEO wouldn't currently be aware of what services are registered for which subscriber. Therefore enhancements to the prior art MEO are required in order for it to be able to fulfil the role of the CNM, according to an embodiment of the invention.

When a third party provides a service, it registers itself with the CNM providing a UserID, MSISDN number, or another unique identity agreed by 3rd parties and the Mobile Operator. The CNM then manages deployment and lifecycle of services on the network.

Should ‘User A’ move back to NB-3 before the configuration period timeout has expired the BBC I-Player pod will still be available and that user will have access to all the edge services that this pod provides with minimal lag and therefore minimal service interruption.

Typically, in prior art systems, cluster routing is managed by the ‘Cluster Network’ shown in FIG. 5. This routes packets to services and between services managing the Virtual IP (VIP) address between the edge cloud (Kubernetes) nodes within the cluster.

In the Enhanced Mobility For MicroServices setup, according to an embodiment of the invention, a cluster may be deployed to a single edge. Routing to the active servers does not change, as packets between the User Equipment (UE) and service still flow directly between the active edge node and the device.

Once a UE attaches to a node (NB) the pod application in the associated edge cloud node makes a PersistentVolumeClaims (PVC), which is the Kubernetes mechanism to request for block storage by a user. For example, in FIG. 5, the UE attaches to NB-1, which will trigger pod 1 to update its state, i.e. active and registered users, plus the associated user context. Through PVCs, data is dynamically persisted to a block storage device for all replicated containers on a Node for a legacy Kubernetes system, but not for a PVC on a different edge network (with its own cluster).

To achieve a consistent persisted context, the service in an Enhanced Mobility For MicroService makes novel use of the cloud system ambassador design pattern to replicate data between edge clusters. This means that when the UE migrates to one ‘static’ edge node from another ‘static’ edge node, no user context update is required. This is because the user context is continually updated to all PVC's for that subscriber. This is described in more detail below, which relates to typical design patterns for cloud compute systems.

There are three primary design patterns for container-based distributed systems. These represent some of the most common use cases for packaging containers together in a pod. Briefly, they are:
1. Sidecar: In this pattern, the secondary container extends and enhances the primary container's core functionality. This pattern involves executing non-standard or utility functions in a separate container. For example, a container that forwards logs or watches for updated configuration values can augment the functionality of a pod without significantly changing its primary focus.
2. Ambassador: The ambassador pattern uses a supplemental container to abstract remote resources for the main container. The primary container connects directly to the ambassador container which in turn connects to and abstracts pools of potentially complex external resources, like a distributed Redis (https://redis.io/) cluster. The primary container does not have to know about the actual deployment environment to connect to external services.
3. Adapter: The adapter pattern is used to translate the primary container's data, protocols, or interfaces to align with the standards expected by outside parties. Adapter containers enable uniform access to centralized services even when the applications they serve may only natively support incompatible interfaces.

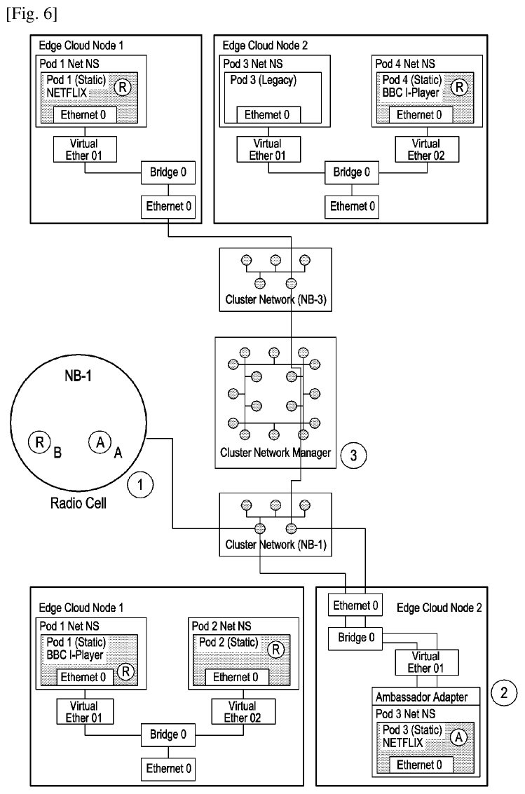

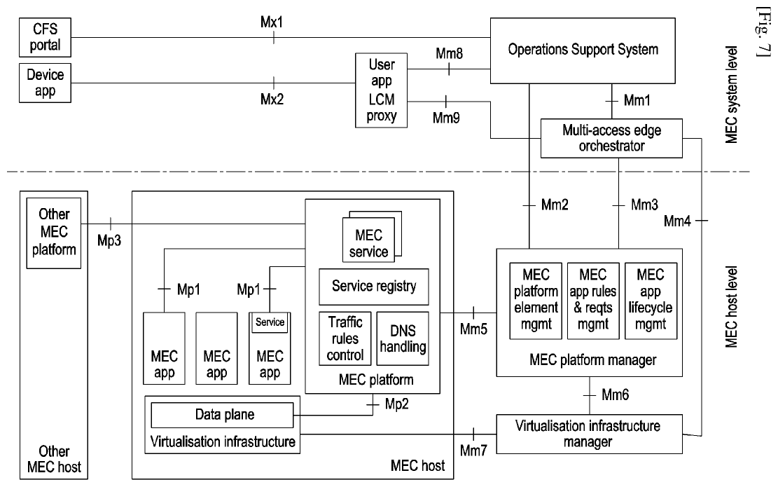

The Enhanced Mobility For MicroServices, according to an embodiment of the invention, implements an ‘Ambassador’ pattern which is used to synchronise context to other replicated services which are not be part of the same Cluster network (i.e. another edge cloud node or roamed edge network). This is shown in FIG. 6, where the following steps (-21-ehavio 1, 2, 3) apply.

Step 1: User A, who is active, updates their context (i.e. interacts with the service) and data flows to the Netflix Tod′ via the cluster network for NB-1. The Netflix pod located in Edge Cloud Node 2 of cluster network NB-1 is shown with an active user.

Step 2: The application for Enhanced Mobility is able to make use of the ambassador pattern to check with the CNM as to what other cluster networks have a Netflix service for that user (to determine whether the context needs to be-21-ehavior-21-zed with other pods). Alternatively the application using the ambassador pattern will be instructed by the CNM that context sync is to be performed. This may be when the pod is deployed and may also be changed throughout the pod's lifetime. The context update is replicated to the CNM.

Step 3: The CNM identifies any other cluster networks with the Netflix service which is ‘static’ and has that user ‘registered’, or predicted to be ‘active’ in the future (for instance based on historical data, or the user's current direction and speed). The CNM then routes the message (i.e. that containing the required context updates, either a delta on the existing context, or a full replacement) to those cluster networks for that edge network. Therefore messages are automatically routed to the Netflix Tod′ running on Edge Cloud Node 1, Pod 1, where the user is shown as ‘registered’.

Alternatively, the CNM may control the routing, but will facilitate direct communication between the cluster networks to transfer the context, thereby avoiding the need for the context to traverse the CNM.

Step 2 and step 3 do not necessarily need to be repeated each time a user context is updated, as long as the pods offering the Netflix service in the other cluster networks are maintained in ‘static’ state whilst a user's context is being transferred there. This can be achieved by setting the subscriber's state to ‘registered’ at those other cluster networks in response to a subscriber's user context being copied there and also by not applying the ‘configurable time period’ to the associated pod during the copying period.

The message flow set out above does not have to occur in real time. Since the handover is not instantaneous between NBs as long as the service is persisted via a Tod′ or directly to the PVC for that edge network. The user context is always in sync for the edge cloud nodes running the user's service.

In the description so far, reference has been made to a generic form of network. The description which follows relates more specifically to ETSI MEC and provides more details of that specific configuration. It is not intended to be limiting but, rather, to offer a specific embodiment, described in terms related to the ETSI MEC configuration.

Embodiments of the invention provide a means to instantiate service-providing application servers at particular locations (on MEC hosts) based on predicted user-22-ehavior in order to minimize the time taken to bring such services into operation. With this approach, application servers are then able to be removed in a controlled manner. This is because if a user has previously interacted with the service, it is desirable that the current user specific context is made available immediately when the user reconnects to the application server in order to avoid service interruption. This is regardless of whether the service is then offered through the original application server, or by an alternate application server if the user has moved location.

In the ETSI MEC system architecture, illustrated in FIG. 7, the centralized MEC Orchestrator (MEO) is the entity responsible for making requests for application server instantiation to each MEC Platform Manager (MEPM) and has MEC system wide visibility (i.e. knowledge of MEC host availability). On this basis, the MEO is the preferred location of the Cluster Network Manager (CNM) functionality described previously.

In the ETSI MEC system architecture, the MEC Platform (MEP) offers access to edge services and may collect service-related usage statistics through monitoring functionality. The MEP, along with the supporting virtualization infrastructure, is contained within the MEC host. The overall MEC system may consist of many MEC hosts, which are geographically distributed in order to provide services close to the end user. Therefore the MEC host is considered analogous to the distributed edge cloud node described previously.

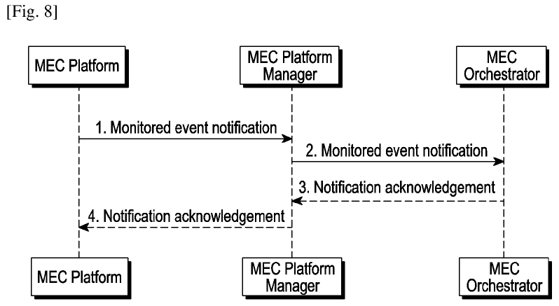

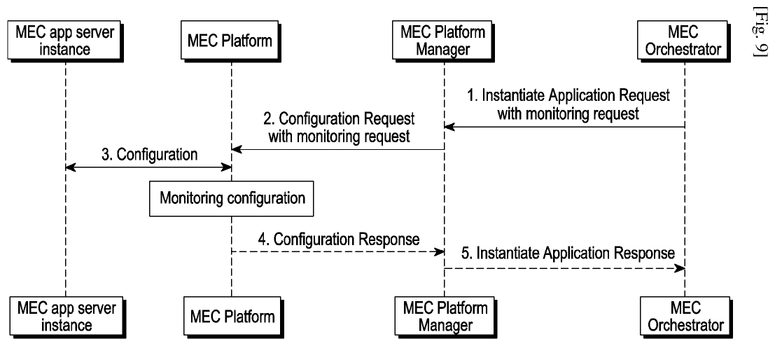

In order to support prediction of user-23-ehavior, embodiments of the invention support a mechanism to share the MEP collected service utilization (e.g. service API statistics) with the centralized MEO, since in the present ETSI MEC specifications there is no mechanism through which the MEO can be made aware of what services users are utilizing and through which application servers. This mechanism may be subscription-based and allows the MEO to be notified when a particular service is being actively used, potentially with user level granularity. This is shown in FIG. 8.

With reference to FIG. 8, a notification channel may be established directly from the MEP to MEO (rather than having to pass via the MEPM). The subscription could be established when the MEO originally makes the application instantiation request to the MEPM (see FIG. 9), or there may be a separate request. Individual user identity may be anonymized using a “tag” to represent a user, which is a concept already provided by ETSI MEC. The MEO then possesses the necessary information to develop a statistical system-wide model in order to predict when a service is likely to be required at a particular location. The prediction may be used to make user specific decisions regarding application instantiation, ensuring consistent persisted application user context through the use of the ambassador design pattern to replicate data between edge clusters.

If user specific information cannot be made available, then application server usage information is still relevant in making application instantiation decisions. However, it would then not be possible for the MEO to directly trigger the process by which user specific contexts are made available as part of the instantiation process. Therefore there would likely be a delay in re-establishing the service for a particular user whilst their user specific state was made available at the application server.

If user specific information can be made available, that information may also be used to influence whether the MEO instantiates application instances at other locations. For example, if predictions indicate that a user is likely to connect to a particular NB at a certain time but it is already connected elsewhere then the MEO may not instantiate the instance at the predicted location at that time.

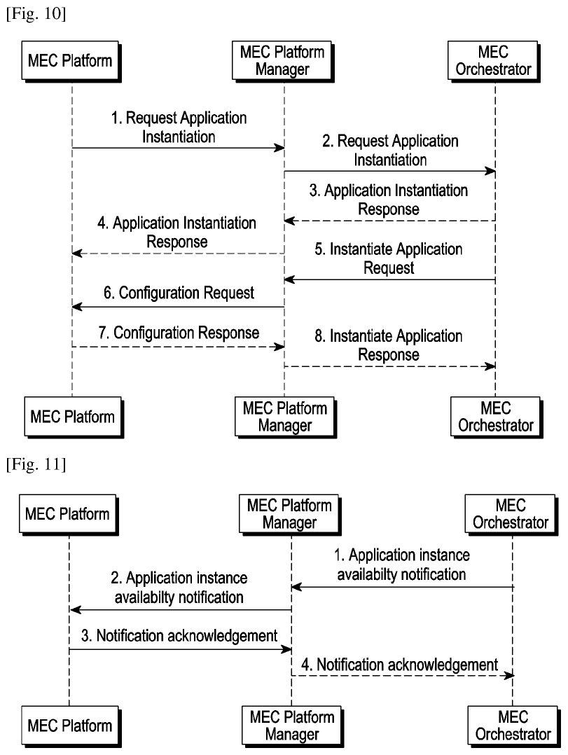

In an alternative embodiment, the MEP may develop its own distributed application server utilization model, which may be user specific. Such models may be developed per MEP in isolation. However, there may be advantages in supporting a communication channel between MEPs to share application server instance information and potentially user specific utilization of those instances between one another. ETSI MEC has defined the Mp3 reference point between MEPs, but information exchanges and APIs are not currently specified for that reference point. By use of such a channel, information may be shared system wide without necessarily involving the MEO, although with the current architecture, the MEO would have to be requested to instantiate an application server (such a request is not currently specified), as set out in FIG. 10. The MEO is best placed to share with each MEP on which other MEC host's application server, instances of interest are located, since the application instance instantiation requests originate from the MEO. Therefore, in embodiments of the invention, the MEO is able to share the location and/or address of all other relevant application instances on other hosts with a particular MEP when making each application instantiation request (see FIG. 7).

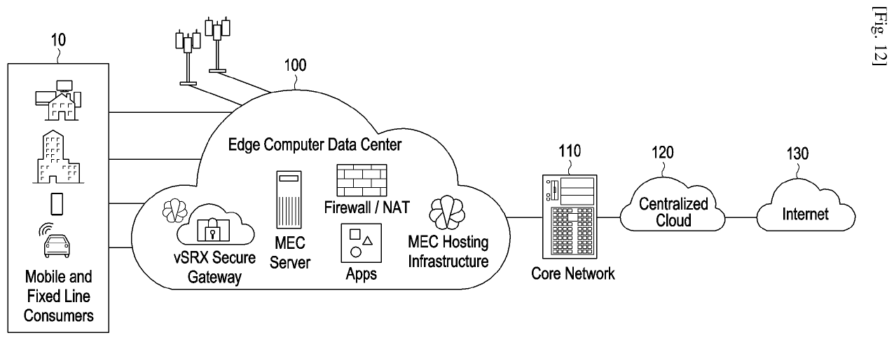

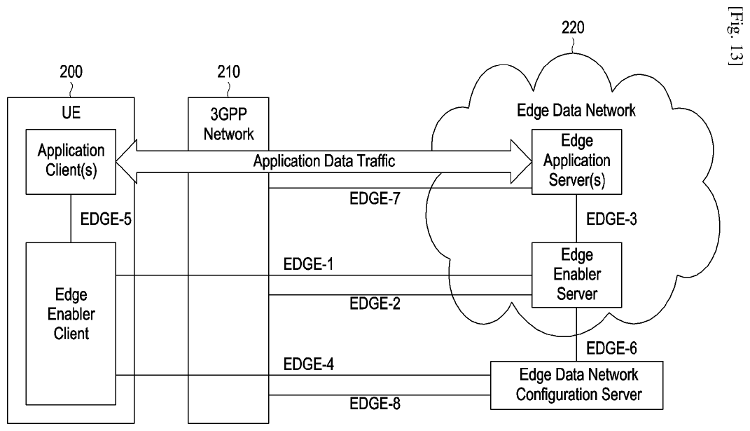

Further, updated information is provided through a notification mechanism should there be changes in application instance location(s)/address(es), as shown in FIG. 11, which shows where, alternatively, notifications may be sent directly from the MEO to a MEP, rather than via the MEPM. Within the existing MEC specifications, the application instantiation request message sent from the OSS to the MEO provides the location constraints for application server placement, but it is only the MEO that is aware of all the instantiated application serve instance locations. Therefore the existing mechanism is insufficient. With an embodiment of the invention, by providing relevant application instance information on other hosts, each MEP then knows with which other MEPs to share relevant monitoring related information, e.g. that a certain user has connected to certain application instance and where to copy user context information to. Alternatively each MEP could query the MEO for the address/location of other relevant application instances.

The monitoring information collected by the MEP and passed to the MEO, and/or other MEPs, may have wider scope than just service utilization. For instance, it may include typical API logging information such as number of API calls, methods invoked, success rate of such requests, request response times. Such information could also feed into the MEO's application instantiation decision making process, since if a certain host is considered to be offering poor performance the MEO may decide not to instantiate on that host and rather steer users towards an alternative host.

Within ETSI MEC, an Application Mobility Service (AMS) has been specified. This enables service consumers, e.g. application instances, to register with the service and then benefit from MEC assisted application mobility, for example in the process of transferring user context between application instances on different MEC hosts. The AMS provides an indication to an application instance that user context transfer is required and with that the target address the application instance should send the context to. The application instance is expected to inform the AMS about connected users (client applications), e.g. new connections to the application instance, and the status of application context transfers, e.g. when a transfer has been successfully completed. This enables the AMS to monitor relevant user specific events, such as those relating to handover. In support of application mobility the application descriptor (containing the necessary information to instantiate an application instance) has been enhanced to provide indication that the application supports user context transfer capability.

The current AMS is reactive in that user context transfer is only initiated after the user (UE) has handed over from a NB associated with the source application instance to a NB associated with the target application instance. Embodiments of the present invention deal with enabling pre-emptive measures to avoid service interruption, which involves using the ambassador application to offer an enhanced AMS and CNM capabilities at the MEO.

As an initial step, the application descriptor is enhanced to include an attribute to indicate that the described application supports ‘user context copy capability’. This implies that associated application instances have means to copy a user context, and any subsequent updates to that context (either as a complete copy, or just the deltas), to a given location, e.g. a storage location at a potential target MEC host. This is via the proposed ambassador application. Also, an application instance of such an application is able to-26-ehavio that user specific context at the target application instance should the user switch to that instance and in that way continue their session without interruption, e.g. continue watching their Netflix movie. The consequence is that an instance of such an application is able to-26-ehavio the stored user context should the user disconnect from the application instance and then reconnect at a later time. This facilitates a quick transition from ‘registered’ to ‘active’ state described earlier, since the user context relevant for the ‘active’ state would be readily available.

The method used to indicate which application instance locations the source application instance should copy, and then subsequently update, the user context to was described earlier, i.e. by including information on other relevant application instances as part of the application instantiation process, which means that information is available at the MEC host. In the context of embodiments of this invention, this implies that the CNM makes that information available to the ambassador application associated with the application instance.

In an alternative embodiment, the ambassador application could query the CNM to provide that for a user when they connect. It is also possible that a subset of relevant application instances could be selected for a particular user based on user specific characteristics, e.g. based on a model of historical-27-ehavior, or based on current-27-ehavior such as the user's current speed and direction of travel. Since such information is dynamic in nature, the ambassador application is a suitable way of maintaining and providing up to date information on where to copy user context.

The steps associated with the use of the proposed enhanced AMS are:
1. Application instance, associated with a stateful application, registers with the enhanced AMS at the current edge host.
2. If the application instance provides indication that it supports ‘user context copy capability’, the AMS provides default list of locations (relating to other instances of the application at different hosts) that user contexts should be copied to. The list will be used by the ambassador algorithm associated with the application instance.
3. Application instance notifies AMS that a user application client is communicating with it. The subscriber will now be considered in ‘active’ state, as in Step 1 described previously. If there is an available user context for that subscriber, that will be utilised for the session with the client application. The location of the stored context may already been known to the application instance for a subscriber that was in ‘registered’ in state, otherwise the AMS can provide that. The application instance may also notify any backend component, e.g. a cloud component to the overall application.
4. If requested the AMS will provide the storage location of user context to the application instance, if it is available. The AMS may also provide a user specific list of locations associated with application instances that user contexts should be copied to (the overall list is maintained by the CNM, at the MEO), linked to Step 2 described above. The list overwrites the default list of (2.) above.
5. The application instance, e.g. utilising the ambassador application described earlier, then copies the current context and any subsequent updates to the provided locations, linked to Step 3 described above. Locations may include those associated with application instances to which the user application client previously connected with.
6. Next if a user performs a handover to a NB associated with a new edge host it will then communicate with the application instance at that host. Communication with the previous application instance will cease and the user will transition from ‘active’ to ‘registered’ state. The process then repeats from step 3.

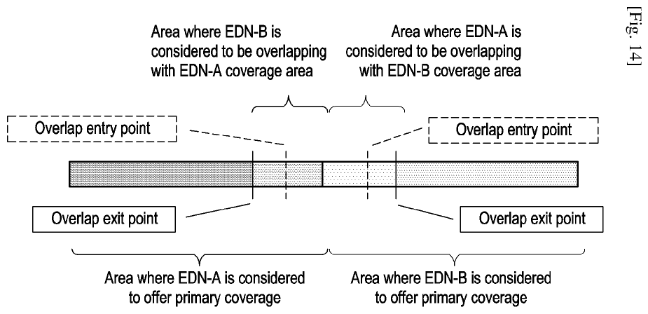

FIG. 13 shows a typical scenario and certain network elements or entities which are relevant to embodiments of the present invention.

A User Equipment 200 is in communication with a wireless cellular network 210. In this example, a 3GPP network is shown, but other forms of network, operable to one or more other standards are applicable. The telecommunication network 210 is in communication with an Edge Data Network (or MEC) 220. Various other entities are shown, as well as certain communication paths, and these will be described in more detail as required.

The problem addressed by embodiments of the present invention may be summarised as when a UE hands off to a new location, a different application server instance may be more suitable for serving an UE's application client. Such application server instances may be hosted in the cloud or within an edge data network. When a switch is made between application server instances, it is desirable that there is no service interruption. Embodiments of this invention address the problem of seamless service continuity.

As mentioned previously, existing methods are reactive. Some of these are as defined in the 3GPP standard(s). With such methods, application user context relocation is only initiated once an alternative application server instance has been deemed to be preferable. As a consequence, there will be a service interruption during the application user context relocation.

According to an embodiment of the present invention, a number of alternative approaches are described.

Firstly, seamless service continuity actions are managed by the network, rather than by the UE. This includes detecting a UE's presence within an overlapping region of coverage of application server areas, through a network-hosted geolocation algorithm, which is able to use user plane (UP) management information and information from the UE as inputs. Also, UE-specific characteristics are included in the overlapping area definition and separate criteria are defined for entry and exit into an overlapping area to prevent a UE “ping-ponging” between being considered in and out of an overlapping area. This may be considered a form of hysteresis. Further, the network takes responsibility for invoking the traffic rules in the data plane to ensure that the application layer traffic is routed towards the duplicated application server instances serving an overlapping area. Further, a mechanism is provided to compare responses from the duplicate application server instances to ensure synchronisation is being maintained, triggering resynchronisation procedures if that is not the case.

The approach to seamless service continuity according to an embodiment of the present invention assumes that overlap areas (geographic regions) are defined between Edge Data Networks (EDNs or MECs) (and also between each EDN/MEC and the cloud, noting that there may be geographic regions not covered by an EDN) and that seamless service continuity measures are triggered for a particular UE once it enters the overlapping area (assuming it is being served by an EAS instance host by one of the EDNs).

The EDN coverage area may be partitioned into one or more application service areas, in which case the overlapping areas are defined between application service areas. This approach is described on the assumption that the EES manages the seamless service continuity measures, but it is also possible that the EAS could be more directly involved.

The EDN Configuration Server (EDNCS) may be used to maintain the overlapping area definitions (including which EDNs are associated with each overlapping area) and to provide the necessary information to each EES to allow it to manage required seamless service continuity actions. However, it is also possible that the EESs themselves maintain the overlapping area definition (again, each with its associated EDNs). In order to support transitions between the cloud and an EDN, there may be an EES associated with application instances hosted in the cloud. The information associated with an overlapping area will include its geographical area, e.g. specific co-ordinates and the EDNs (or application service areas) associated with it. If the overlapping area definition is maintained centrally, each EES will provide feedback information to the EDNCS to allow further fine tuning of the definitions (e.g. how long resources in the neighbouring EDNs were reserved for before they were required by the client application).

Fine tuning may be required to optimise the size of the overlapping area, which may be configured to be an ongoing process. If too large, additional resources in neighbouring EDNs are more likely to be reserved unnecessarily. If too small, a UE may handover to a new cell associated with a different EDN before the required EAS instance is available in that neighbouring EDN.

The size of the overlapping area may also be tuned according to UE characteristics. For instance, a UE identified as being on a train, or main trunk road may require the EAS instance in the EDN covering the overlapping to be established earlier due to the UE speed, compared to a more slowly moving UE, e.g. a pedestrian. Therefore, a larger overlapping area may be established for a highly mobile UE as compared to a low mobility UE.

The defined boundary may also be specified differently depending on whether a UE is entering or leaving an overlapping area (to prevent ping-pong between being considered in or out of an overlapping region). This is a concept akin to hysteresis, with different threshold defined for entering or leaving the area. Therefore, there may be multiple overlapping area definitions per EDN, which may, for instance, be application service area specific, or may even be UE specific, or applicable to groups of UEs with similar characteristics, or even per UE and application specific.

Furthermore, a decision may be made to expand or shrink the size of the overlapping region based on changes to edge data network resource availability. For instance, during a period of heavy loading, where the active application instances are consuming a significant proportion of the available resources, it may be desirable to shrink the overlapping region to reduce the amount of resource reserved in neighbouring EDNs. Should such a decision be made, if a different entity is responsible for the overlapping area definition it should be made aware, e.g. the EES informing the EDNCS.

Assuming the overlap region has been made available to the EES of the serving EAS instance then, if the UE location can be provided to the EES (with sufficient accuracy and precision), the EES is able to use the geographic bounds directly to determine whether a UE is within those bounds. However, it is likely that secondary indirect sources of UE location will also be required, since UE location may not always be directly available (e.g. GPS tends not to work indoors). Therefore, a UE's presence within an overlapping area may be determined through a combination of information elements by geolocation capabilities within the EES, for instance:

RF information (serving and neighbour cell RF-related measurements) is already used to make cell change decisions, e.g. if neighbouring cell becomes better than the serving cell, usually based on a threshold. A different set of thresholds may be used to provide an indication that the UE has moved into an overlapping area prior to a handover being triggered.

Timing advance (TA) provides an indication of the distance from the serving cell (it is a measure of the roundtrip time between the base station and a UE), therefore a certain TA could be used as the threshold to indicate the UE has moved into an overlapping area. Note, that TA alone only provides distance and not angle from the serving cell and cannot therefore indicate a direction from the serving cell.

UE serving cell information (3GPP cell identity) may be sufficient to define the overlapping area when EDNs are associated with more than one cell, or base-station. If the cell location is known to the EES, then the UE's serving cell location can be assumed as its location when checking whether the UE is with the geographic bounds of an overlapping area.

The information required to determine this may be obtained by subscribing to relevant user plane management notifications from the 3GPP Network (e.g. through the 3GPP capability exposure functions, or via proprietary interfaces), or information from the UE itself. Such notification information may include those previously identified, such as: UE location; RF information; mobility/handover events (including serving cell change); and UE timing advance.

As part of the geolocation process, the information elements used as input may need to be filtered to introduce hysteresis and to ensure a single spurious measurement doesn't trigger seamless service continuity actions unnecessarily. The appropriate trigger thresholds for these additional information elements may be signalled to the EES, or determined by the EES itself.

In the following, the flow of events according to an embodiment of the invention is described for a situation in which a UE's application client is served by an EAS instance within a first EDN (EDN-A). The UE then moves into an overlapping region and it hands over to the coverage area associated with a second EDN (EDN-B). It then finally moves out of the overlapping region. The flow highlights the steps necessary to maintain service continuity during these transitions. First the pre-conditions are described and then the full flow is presented.

The pre-conditions are:

EAS instance 1 (EAS ins1) is hosted within EDN-A and EAS instance 2 (EAS ins2) is hosted within EDN-B. Both are instances of the same EAS.

Traffic rules have already been invoked to establish the application traffic path between the Application Client and EAS ins1.

The EAS is available in EDN-A and EDN-B and the EES in each EDN are aware of that

In an alternative embodiment, the EES may invoke procedures to establish an appropriate EAS instance in EDN-B once a UE has been detected as being in an overlapping region. Such instantiation procedures would ensure services consumed by the application instance, e.g. services provided by the underlying transport network, are made available.

There has been interaction between the EDNCS and EES-A to establish the necessary overlapping areas that may be dynamically updated.

The largest overlapping area is defined with respect to an EDN's coverage area, i.e. the radio access network cells that are associated with it. However, an EDN coverage area may be split into smaller areas based on EAS service areas

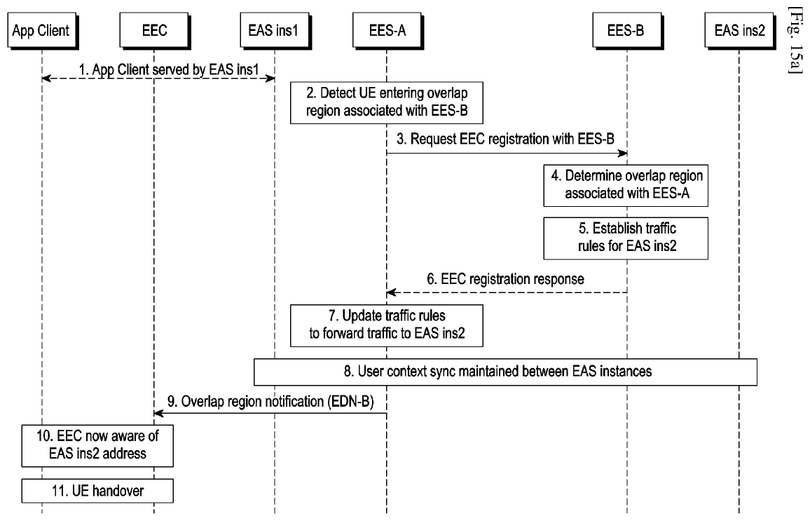

The entry and exit point into an overlapping area may be different to introduce hysteresis to prevent a UE ping-ponging between being considered in and out of an overlapping area. This is illustrated in FIG. 14, which shows the overlap entry point and exit points being different. It also illustrates the nature of the overlap between EDN-A and EDN-B and when each of EDN-A and EDN-B is considered to offer primary coverage. The entry and exit points may be fine-tuned according to UE characteristics, e.g. velocity, vehicular status (potentially associating with a specific road), pedestrian status.

In particular, the figure shows how there's an overlapping area where EDN-B is considered to be overlapping with EDN-A and also an overlapping area where EDN-A is considered to be overlapping with EDN-B.

The overlapping area may be dynamically adjusted according to EDN resource availability

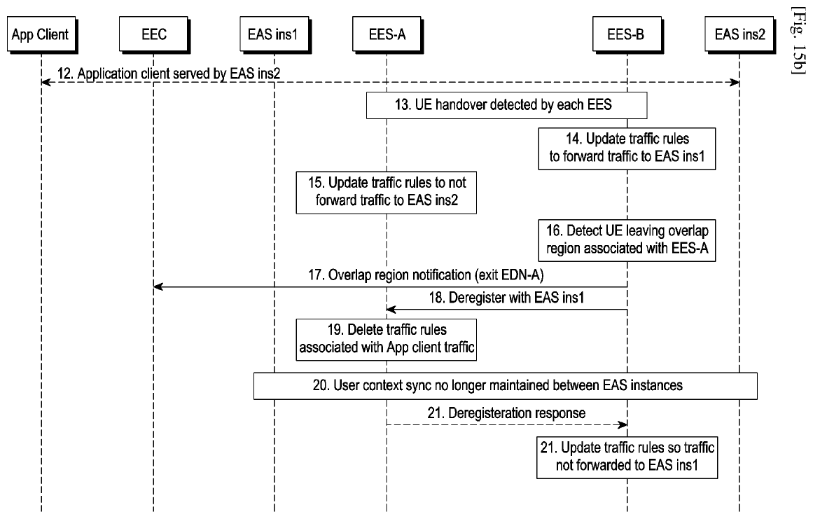

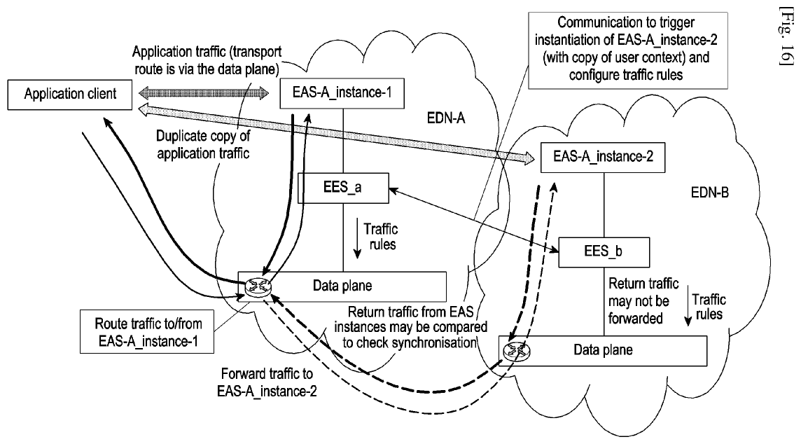

The flow, shown in detail in FIGS. 15a and 15b, includes the following steps or messages:
1. The application client is served by EAS ins1. Application traffic is routed via the data plane, which is implemented by the User Plane Function (UPF) in the 3GPP Service Based Architecture (SBA)
2. EES-A detects that the UE (hosting the application client) has moved into the overlapping area where EDN-B is considered to be overlapping with EDN-A

Detection may be through utilization of user plane management information (e.g. cell ID, TA, measurement reports)

In an alternative embodiment, detection of a UE entering an overlapping region may be performed by a centralized entity (whether that be a centralized EES that interacts with each distributed EES, or the EDNCS). In this case procedures such as those in the next step are initiated by the centralized EES, rather than EES-A. As in the distributed detection cases, the centralized entity would still need to be provided with access to information relevant for detecting a UE's location (whether it determines the location itself using such information, or is directly provided with the UE's location). Location in this context is not limited to geographical coordinates and could simply be the UE's radio access serving cell identifier.

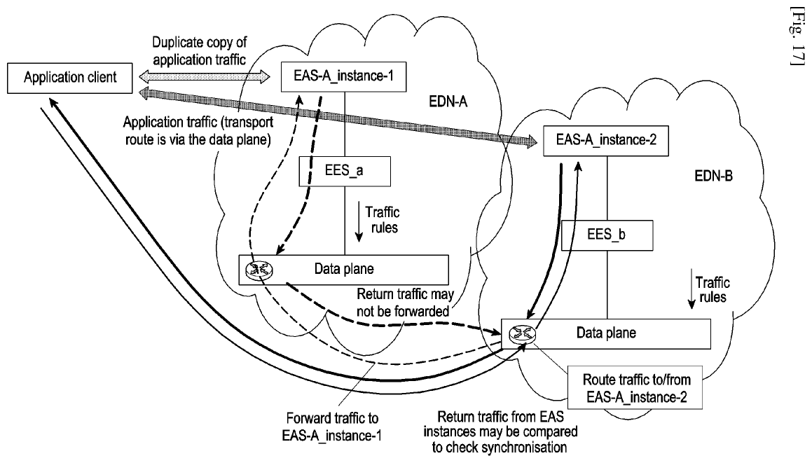

In the case that the application client is currently being served by an application instance hosted in the cloud, EES-A would refer to the EES associated with cloud applications (rather than a specific EDN). The assumption is that although an application client could satisfactorily continue to be served via the cloud, relocation to the edge would offer additional advantages including lower latency.
3. EES-A initiates EEC registration with EES-B (either directly, or potentially through an orchestration layer). The registration indicates that there is active EAS instance (namely EAS ins1). Alternatively, EES-A could send a request to the EEC for it to initiate the registration with EES-B
4. Through interaction with the EDNCS the overlap area where EDN-A is considered to be overlapping with EDN-B is established at EES-B (this may be UE and EAS specific).
5. Establish traffic rules for EAS ins2.
6. Acknowledgement sent to EES-A.
7. EES-A now updates its traffic rules. The resulting traffic flows after these 3 steps are highlighted in FIG. 16, which is described in more detail later.

The established traffic rule (the terms routing and steering are also used in this context) procedures in the data plane to steer traffic to the serving EAS and also the same traffic to the duplicate EAS (once it is up and running) will ensure application user context synchronization is maintained. This is since the duplicate EAS instance will believe it is serving the application client and respond accordingly (for instance, considering a video delivery application, both application instances would be serving the same video frame at the same time). Responses from the duplicate EAS instance will not be forwarded to the client application. However, the responses may be compared (without necessarily needing to examine the application layer content) to those from the serving application instance to ensure alignment of the user state in the duplicate EAS instance. Should a discrepancy be detected, re-synchronization steps should be invoked, e.g. re-copying of the stateful components of the application user context. Due to the lag between the two EDNs, it would be expected that the response from EAS ins2 would be behind that from EAS ins1 and therefore this offset would have to be accounted for in the comparison.

If the EAS instance has a backend connection, for instance to a companion application entity in the cloud, traffic rules associated with that connection would also have to be updated to ensure traffic originating from that entity also reflected at EAS ins2.
8. Application user context synchronization between the two application instances will now be a continuous process (as highlighted in the previous step) whilst the UE is the overlapping area region.

It's possible that in order to achieve initial synchronization a snapshot of the source application instance will have to be copied across to the target EDN (EDN-B) and resumed there (e.g. Docker container checkpoint of EAS ins1 and Docker container start as EAS ins2 hosted by EDN-B). An acknowledgement that EAS ins2 is in running state would then be sent to EES-A via EES-B. Any traffic from the application client targeted towards EAS ins1 during the initial synchronization process should be forwarded onto EAS ins2 once the acknowledgement that the instance is running has been received. It is important to note that EAS ins1 need not be stopped or paused, whilst synchronization is achieved with the duplicate application instance.

If an EAS is consuming EDN specific services (an example service could include UE location, which may originate from the underlying network, e.g. 3GPP access network) those services would have to be re-established as part of the synchronization procedures. In some instances, those services would have to be provided via the source EDN whilst the application client was interacting with EAS ins1 and only switched to being provided target EDN once the application client switched to interacting with EAS ins2.

The behavior of some applications may mean that it is not appropriate to have multiple instances at the same time. In such cases, the application instance in EDN-B would be synchronized to the latest available state of EAS ins1 and then post UE handover EAS ins2 would be started with the most up to data state of EAS ins1 in order to minimize service interruption, although in this case there would likely be a short interruption whilst EAS ins2 was transitioned into running state.
9. EES-A informs the EEC that the UE is an overlapping region.
10. The notification from EES-A provides the EEC with the EAS ins2 address to facilitate seamless transition between application instances post-handover.
11. If the UE continues to move, there will be a UE handover between a cell associated with EDN-A and a cell associated with EDN-B. This is the trigger for switching serving EAS instance (since EAS ins2 is now considered the preferred server, e.g. it better fulfils the application KPI requirements). The UE will now be in the overlapping area where EDN-A is considered to be overlapping with EDN-B.
12. After successful handover the application client will be communicating with EAS ins2, which has an identical application user context to EAS ins1 and therefore seamless service continuity is achieved.

There may be explicit signaling to trigger the Application Client to switch to EAS ins2, e.g. EEC to Application Client interaction. The switch may be delayed until both EES-A & B have updated their traffic rules and confirmation of that has been signaled to the EEC.

For an application where only the application user context is synchronized, but which is not run in duplicate, the communication from the application client will act as the trigger to switch EAS ins2 into running state based on the latest available context.
13. Both EESs will be notified of the handover, e.g. through subscription to relevant access network notifications.
14. EES-B updates its traffic rules. This update may be signaled to EES-A to trigger EES-A to update its traffic rules.
15. EES-A updates its traffic rules. The resulting traffic flows after these 2 steps are highlighted in FIG. 17, which is described in more detail later.
16. As the UE continues to move it moves out of the area where EDN-A is considered to be overlapping with EDN-B coverage area.
17. Should this occur, then EES-B notifies the EEC that it has move out of the overlapping region and it will therefore no longer be registered with EES-A.
18. EES-B signals to EES-A to deregister the EEC.
19. EES-A then deletes (deactivates) traffic rules associated with the application client.
20. EES-A response to EES-B. to acknowledge the deregistration
21. EES-B updates its traffic rules so that traffic is no longer forwarded to EAS ins1.

After step 21 above, the UE is considered to be in a non-overlapping area and is server exclusively by EAS ins2.

In an alternative embodiment where multiple instances of an application are not run at the same time, but application user context synchronisation is still maintained, steps 5, 7, 14 & 15 would not apply. In this case, the application user context available in EDN-B is kept up to date with that in EDN-A. The result is that when the application client connects to EAS ins2, up to date application state information is already available without having to fetch it from EDN-A.

FIG. 16 shows application level traffic between an Application client and the serving Edge Application Server (EAS) instance 1 (thick double-ended arrow) of an edge application being duplicated to Edge Application Server instance 2 (thick double-ended arrow) for a UE that is in an overlapping region. Application level traffic is transported via the data plane (thin arrows). In Edge Data Network A (EDN-A), the Edge Enabler Server A (EES a) configures the data plane to route traffic between the Application client and its serving EAS instance (EAS-A_instance-1) using traffic rules. The data plane is also configured to forward traffic from the Application client to the duplicate EAS instance (EAS-A_instance-2) hosted in EDN-B via the data plane in EDN-B (thin dashed arrow).

A pre-condition is that the application user context associated with the application client has been made available in EDN-B to ensure EAS-A_instance-2 is synchronised to EAS-A_instance-1 before traffic is forwarded to it and that EAS-A_instance-2 is up and running Traffic received from EAS-A_instance-2 in EDN-A (thin dashed arrow) is not forwarded to the Application client, but may be compared to the traffic that is received from EAS-A_instance-1 to check that the two EAS instances are in sync. This is only if the data plane in EDN-B has been configured to forward traffic from EAS-A_instance-2 to EDN-A. If the edge application has a (backend) cloud component, steps will be put in place to ensure any communication with the cloud component is reflected at EAS-A_instance-2. Whilst this duplication is maintained between the two application instances, the two instances will remain in sync such that the application user context will be aligned across both instances.

FIG. 17 shows the updated scenario when the instance to which the Application client is connected, has switched from EAS-A_instance-1 to EAS-A_instance-2. The trigger for such a switch could be a UE handover in the underlying transport network, resulting in EAS-A_instance-2 being the preferred server due to the UE's location and the access point through which it is connecting to the transport network. Now the application level traffic between the Application client and the serving Edge Application Server (EAS) instance 2 (thick double-ended arrow) of an edge application is duplicated to Edge Application Server instance 1 (thick double-ended arrow). In Edge Data Network B (EDN-B), the Edge Enabler Server B (EES_b) configures the data plane to route traffic between the Application client and its serving EAS instance (EAS-A_instance-2) using traffic rules. The data plane is also configured to forward traffic from the Application client to the duplicate EAS instance (EAS-A_instance-1) hosted in EDN-A via the data plane in EDN-A (thin dashed arrow). Since the Application client was previously served by EAS-A_instance-1, the application user context associated with the application client will already be available in EDN-A and therefore EAS-A_instance-1 will already be synchronised to EAS-A_instance-2 before traffic is forwarded to it.

Traffic received from EAS-A_instance-1 in EDN-A (thin dashed arrow) is not forwarded to the Application client, but may be compared to the traffic that is received from EAS-A_instance-2 to check that the two EAS instances remain in sync. This is only if the data plane in EDN-A has been configured to forward traffic from EAS-A_instance-1 to EDN-B. Whilst this duplication is maintained between the two application instances the two instances will remain in sync such that the application user context will be aligned across both instances.

The example signal flow shown in FIGS. 15a and 15b is exemplary only and the skilled person will appreciate that certain modification may be made, whilst still falling within the scope of the present invention as defined by the appended claims.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of providing a service in a multi-access edge computing (MEC) network, the method comprising the steps of:
providing a pod in an edge cloud node, wherein the pod comprises a software container for providing an application that offers a service to one or more subscribers; and
associating with the pod a status related to an active or registered subscriber, wherein an active subscriber is currently interacting with the pod and a registered subscriber is not currently interacting with the pod, but has interacted previously,
wherein, provided that the pod has at least one registered subscriber, the pod is maintained in the edge cloud node.

2. The method of claim 1,
wherein a particular subscriber is held in a registered state until one or more of the following conditions apply:
a configurable time period has elapsed;
the particular subscriber is no longer registered with the service; or
the particular subscriber becomes an active subscriber, and
wherein the configurable time period is determined on the basis of behaviour patterns of one or more subscribers.

3. The method of claim 2, wherein if the pod has no active or registered subscribers, the pod is deleted.

4. The method of claim 1,
wherein a user context associated with an active subscriber at the pod is made available to one or more other pods, and
wherein the user context is made available by means of an ambassador pattern operable to replicate data between the pod and the one or more other pods.

5. The method of claim 4,
wherein determining the one or more other pods is performed on the basis of a prediction of the subscriber's behaviour, and
wherein the prediction is based upon one or more of: the subscriber's previous movements; and the subscriber's current position and/or speed and/or direction of travel.

6. A system comprising an edge cloud node and a plurality of pods operable to perform the method of claim 1, and
wherein the system comprises at least one pod associated with at least one registered or active subscriber, and
wherein the system comprises a cluster network manager operable to manage services available on particular pods.

7. A method of managing user equipment (UE) access to a particular application in a telecommunication network, the method comprising:
serving the UE from a first application server instance;
detecting the UE's presence within an overlapping region of coverage between a coverage area of the first application server and a coverage area of a second application server; and
as a result of the detecting, establishing a duplicate of the UE's application user context at the second application server instance.

8. The method of claim 7,
wherein one of the first and second application servers is associated with a multi-access edge computing (MEC) network, and
wherein the first and second application servers are each associated with a different MEC network.

9. The method of claim 7, wherein a threshold for detecting entry into the overlapping region differs from a threshold for detecting exit from the overlapping region.

10. The method of claim 7, wherein the detecting of the UE's presence within an overlapping region of coverage is based on the UE's location, determined by one or more of:
location information provided by the UE; geolocation of the UE;
radio frequency (RF) signal related information provided by the UE or telecommunication network relating to the serving and neighboring cells;
a timing advance associate with the UE; or
serving cell information.

11. The method of claim 7, wherein a traffic rule is invoked whereby data traffic is steered to both the first and the second application server such that the UE's application user context can be maintained at the first application server instance and the second application server instance.

12. The method of claim 7,
wherein responses from the first and second application server instances are compared to check if synchronization is being maintained, and
wherein if synchronization in not being maintained, initiating a synchronization recovery procedure.

13. The method of claim 7,
wherein the overlapping region of coverage is either static or dynamic,
wherein the overlapping region of coverage is dynamic, it is defined on the basis of one or more of resource availability in the network; and a UE-specific characteristic, and
wherein the UE-specific characteristic is one of pedestrian status; vehicular status; and velocity.

14. The method of claim 7,
wherein the duplicate of the UE's application user context at the second application server instance is maintained until the UE returns to the coverage area of the first application server or becomes served by the second application server instance, and
wherein if the UE becomes served by the second application server instance and is still in the overlapping region, then a duplicate of the UE's application user context is maintained at the first application server instance and if the UE is not in the overlapping region, then the duplicate of the UE's application user context at the first application server instance is deleted.

15. A system operable to perform the method of claim 7.
